(19) United States
(12) Patent Application Publication
(10) Pub. No.: US 2022/0049665 A1
(43) Pub. Date: Feb. 17, 2022

(54) METHOD AND SYSTEM OF ANTI-IDLING CONTROL FOR VEHICLES

(71) Applicants: Amir KHAJEPOUR, Waterloo (CA); Rhyse MARYNIUK, Waterloo (CA); Yanjun HUANG, Waterloo (CA); Soheil FARD, Maple (CA); Milad KHAZRAEE, Waterloo (CA)

(72) Inventors: Amir KHAJEPOUR, Waterloo (CA); Rhyse MARYNIUK, Waterloo (CA); Yanjun HUANG, Waterloo (CA); Soheil FARD, Maple (CA); Milad KHAZRAEE, Waterloo (CA)

(21) Appl. No.: 17/274,608

(22) PCT Filed: Sep. 10, 2019
(86) PCT No.: PCT/CA2019/051266

§ 371 Date: Mar. 9, 2021

Related U.S. Application Data
(60) Provisional application No. 62/729,110, filed on Sep. 10, 2018.

(51) Int. Cl. F02D 41/04; F02D 41/08; F02N 11/08

(52) U.S. Cl. CPC F02D 41/042; F02D 41/08; F02N 11/0803; F02N 11/0862; F02D 2200/101; F02N 2200/0804; F02D 2200/70; F02N 2200/022; F02N 2200/061; F02N 2200/102; F02N 2200/122; F02D 2200/50

(57) ABSTRACT

A method and system for anti-idling management for a vehicle including an anti-idling system (AIS) is disclosed. Based on inputs from different sources associated with the vehicle, the AIS determines when anti-idling management should be enabled in order to control the engine of the vehicle. In some embodiments, the AIS includes an AIS battery that can be used to power auxiliary vehicle components when the vehicle is stopped via anti-idling control management.

### CROSS-REFERENCE TO OTHER APPLICATIONS

The current application claims priority from U.S. Provisional Patent Application No. 62/729,110 filed Sep. 10, 2018, the contents of which are hereby incorporated by reference.

### FIELD OF THE DISCLOSURE

The disclosure is generally directed to vehicles and, more specifically, at a method and system of anti-idling control for vehicles.

### DESCRIPTION OF THE RELATED ART

Idling refers to a situation when the engine of a vehicle is running but the vehicle is not moving. Engine idling is one of the contributors to poor air quality, noise pollution, and serious health issues. In addition, it significantly increases fuel and maintenance costs while reduces vehicle life span. For example, diesel engines have efficiencies of about 40% running on highways. However, when idling, their efficiencies drop to under 10% and discharge more pollutants. As such, it is imperative to reduce or even eliminate engine idling. A number of products to reduce idling have been developed by different manufacturers. Generally, auxiliary power units (APUs) and auxiliary battery power systems (ABPs) are the most commonly used products. The former ones employ and integrate a small-scaled engine and generator into a vehicle's original powertrain to power auxiliary devices; whereas, the latter ones replace the engine and generator by a battery pack to power electric auxiliary devices.

The disclosure is directed at a method and system of anti-idling control for vehicles.

### SUMMARY OF THE DISCLOSURE

The disclosure is directed at a method and system of anti-idling control for a vehicle. The system of the disclosure may be referred to as an anti-idling system (AIS) for vehicles. In one embodiment, the AIS includes a controller running on a microcontroller or a computer for service vehicles. The AIS is scalable and intended to be used in service vehicles such as, but not limited to, buses, refrigerated containers (“reefers”), trucks, and recreational vehicles with electrified auxiliary devices such as refrigeration, air conditioning, hydraulic systems, pneumatic systems and auxiliary devices with independent energy sources such as heaters. The AIS is used to reduce/eliminate problems associated with vehicle idling.

In one aspect of the disclosure, there is provided a method for determining if a vehicle should enter an anti-idling state including determining if the vehicle is ready for idling management; determining if the vehicle engine should be shut down; and if it is determined that the vehicle engine should be shut down, shutting down the vehicle engine.

In another aspect, determining if the vehicle engine should be shut down includes determining at least one of is the vehicle in a parked state; is the engine RPM within a predetermined RPM range; is there any speed sensed in at least one wheel; is the brake depressed; is the hood closed; is the lift door closed; is the battery voltage higher than a predetermined low battery threshold; is the state of the charge of the AIS battery is within a predefined range, is the exterior/interior temperature within a predetermined temperature range; is the vehicle undergoing an active regeneration process; and is the turbocharger temperature lower than a predetermined temperature threshold. In another aspect, the method further includes determining if the vehicle engine should be turned back on. In a further aspect, determining if the vehicle engine should be turned back on includes determining if a battery voltage is lower than a predetermined low battery threshold; determining if a state of the charge of an anti-idling system (AIS) battery is lower than a predefined AIS battery threshold and/or determining if an exterior/interior temperature is outside a predetermined temperature range.

In yet a further aspect, the of is the brake depressed includes determining if there is a brake pedal input for a digital brake switch; and determining if a brake pedal value is less than a predetermined brake pedal error threshold for an analog brake switch. In yet another aspect, the method further includes, before determining if the vehicle is ready for idling management, determining parameters for initiating idling management. In another aspect, determining if the vehicle is ready for idling management includes comparing measurements received from vehicle with the determined parameters to determine if a threshold with respect to the determined parameters is met.

In another aspect, the method further includes processing vehicle information to determine vehicle characteristics; transmitting vehicle characteristics to an external party.

In another aspect of the disclosure, there is provided a system for determining if a vehicle should enter an anti-idling state including a set of sensors for sensing vehicle characteristics and generating vehicle characteristic signals representing the sensed vehicle characteristics; and a processor for receiving the vehicle characteristic signals from the set of sensors and for processing the vehicle characteristic signals to determine if the vehicle should enter the anti-idling state and for transmitting vehicle engine instructions based on the processing.

In another aspect, the system further includes a power management module to manage a flow of the energy between vehicle components. In yet another aspect, the vehicle components include at least two of an engine, an OEM battery, an AIS battery, auxiliary devices, an alternator/generator, and power electronics. In yet a further aspect, the system further includes an inertial measurement unit to assist the decision making in the control unit. In an aspect, the system further includes a communication component for communicating vehicle characteristics to an external party. In yet another aspect, the AIS battery is used to power electrified auxiliary devices when the engine is shut off.

In another aspect of the disclosure, there is provided a computer readable medium having stored thereon instructions that, if executed, cause a processor to determine if the vehicle is ready for idling management; determine if the vehicle engine should be shut down; and if it is determined that the vehicle engine should be shut down, shutting down the vehicle engine.

In another embodiment of the present disclosure, the size of the AIS battery and generator are properly optimized, or determined, through a multidisciplinary approach. The AIS is able to recuperate braking energy, and store it in the AIS battery to power the electrified auxiliary devices. The system of the disclosure reduces or minimizes the vehicle fuel consumption by extracting energy for running the auxiliary devices by recovering energy while braking, when the engine runs at high efficiency regions, and also by using the onboard and online information received from different sources including sensors, CAN Bus, GPS, route and stop information, vehicle to vehicle communication and vehicle to infrastructure connectivity.

### DESCRIPTION OF THE DRAWINGS

Embodiments of the present disclosure will now be described, by way of example only, with reference to the attached Figures.

FIG. 1 is a schematic diagram of a control unit;

FIG. 2a is a schematic diagram of another embodiment of an AIS for a vehicle;

FIG. 2b is a schematic diagram of another embodiment of an AIS for a vehicle; and

FIG. 3 is a flowchart outlining a method of anti-idling control for a vehicle.

### DESCRIPTION OF THE EMBODIMENTS

The disclosure is directed at a method and system of anti-idling control for a vehicle. The anti-idling system (AIS) is preferably implemented or integrated within a vehicle control system. While the system may be implemented in any vehicle, it finds benefit in vehicles such as buses, refrigerated containers (“reefers”), trucks, and recreational vehicles with electrified auxiliary devices such as refrigeration, air conditioning, hydraulic systems, pneumatic systems and auxiliary devices with independent energy sources such as heaters.

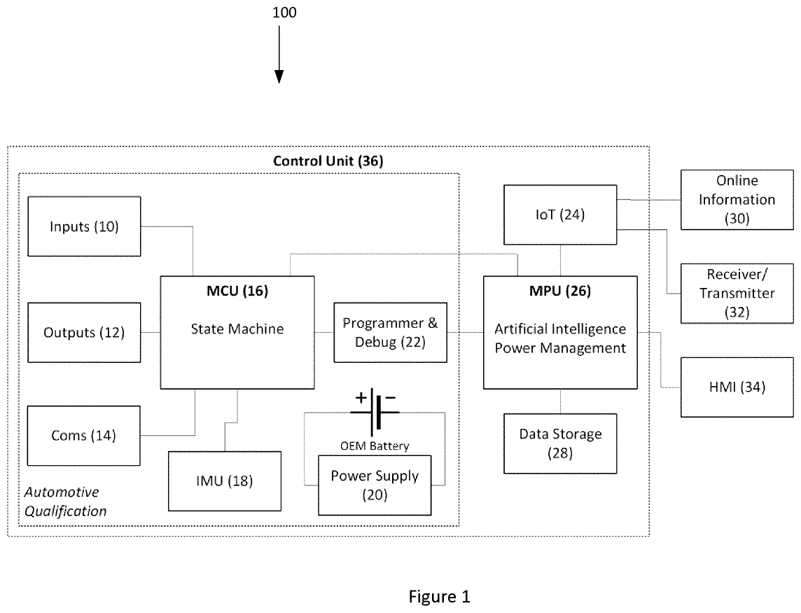

Turning to FIG. 1, a schematic diagram of an AIS is shown. In the current embodiment, the AIS 100 is in the form of a control unit 36 that includes components that may be configured to enable the AIS to operate in the different modes, depending on the design of the AIS 100. For example, the AIS may operate by identifying that idling is occurring and indicating to the driver to turn off the vehicle manually. The AIS may also operate to record, analyze, and transmit idling information for fleet analytics and subsequent policy decisions. In the current embodiment, the control unit 36, or AIS system 100 includes components for enabling anti-idling in a vehicle by controlling the components of the vehicle based on the processing of information by the AIS 100.

The AIS 100 includes a microcontroller unit (MCU) 16 that is connected to a programmer & debug component 22 that are both connected to an artificial intelligence power management system micro-processing unit (MPU) 26. In operation, the MCU 16 processes input data, seen as inputs 10 and communications 14 to determine if anti-idling should be enabled and then based on the processed information transmits control actions to the vehicle, seen as outputs 12. Although described with respect to a vehicle, it is understood that the anti-idling system 100 may be used for anti-idling control of other devices such as auxiliary power units, construction equipment, or generators.

The input signals or data may include analog and digital voltage signals received from the vehicle or may be the outputs of sensors associated with the vehicle. Examples of sensors include, but are not limited to, temperature sensors, pressure sensors and/or current sensors. The MCU 16 is also connected to an inertia measurement unit (IMU) 18 that may determine vehicle accelerations. The sensed vehicle acceleration measurements may be seen as a further input to the MCU 16. The outputs 12 are used to control components or devices within the vehicle such as motors, actuators, or relays to influence the operation of the vehicle or component to which the AIS 100 is attached and/or connected. Communication between the MCU 16 and other external components is via a Coms component 14 using known communication standards including, but not limited to I2C, SPI, UART, CAN, and FlexRay. The control unit 36 further includes a power supply 20 enabling it to be powered by a range of automotive electrical supplies or may be powered by a stand-alone, preferably rechargeable, battery.

The MPU 26 may also be seen as a processing unit, or processor, which enables non-critical i.e. not safety-related functionality data to be processed. Although not shown, the MPU 26 may include internal and external storage, USB ports, RJ45 ports, audio ports, and/or display ports. A human machine interface (HMI) 34 enables users to interact with the system 100 using interfaces such as light emitting diodes (LEDs), buttons, buzzers, and/or displays. The MPU 26 is programmed to execute high-level operational algorithms such as, Internet of Things (IoT) management, security routines, update routines, user environments, and artificial intelligence such as self-learning algorithms or neural networks. The connection between the MCU 16 and MPU 26 allows for actions such as creating log files, sending information to an online information system 30, performing computation on input data, or sending commands between the MCU 16 and MPU 26.

In one embodiment, The IoT component 24 is managed by the MPU 26 and may be seen as the connectivity component for the system 100. Using wireless and wired communication protocols such as WiFi, Bluetooth, Ethernet, Cellular, LoRa, Sigfox, and GNSS, the system 100 may send and receive messages and commands to/from the online information system 30 (or other devices capable of communicating with the system) and fulfil the connectivity requirements of the AIS 100. In one embodiment, the online information system may be seen as the Cloud. The IoT component 24 may be attached to an external receiver/transmitter 32 antenna to amplify the signal strength. In one embodiment, the IoT component 24 enables two-way communication between the AIS and external parties (such as a fleet manager) to monitor and manage the vehicle. For instance, the AIS 100 may transmit information with respect to fuel consumption or fuel efficiency through the IoT component 24 whereby a fleet manager may be able to adjust vehicle routes in order to improve fuel efficiency. If a vehicle route is to be adjusted, the fleet manager can then transmit this information back to the AIS 100 (or to the on-board vehicle control) via the communication component 24. In some embodiments, the fleet manager may transmit other information to the AIS 100 via the communication component 24. For example, the system 100 can notify drivers of fleet wide announcements of varying urgency via the HMI 34. The driver can interact with the AIS 100 to signal acknowledgement of the fleet notification, which can be transmitted back to the fleet manager. In other embodiments the flow of information can go in the reverse order, with the driver notifying the fleet staff of pertinent information. The driver can transmit information such as a discovered vehicle issue or notifying dispatch that passengers have been picked up, which can then be acknowledged by fleet staff.

The system 100 is preferably implemented or isolated into two different qualification regions or sections with the MCU 16 and its supporting hardware qualified for automotive applications. Specifically, the electronic hardware in this region preferably conforms to the AEC Component Technical Committee while the MCU 16 preferably conforms to the ISO 26262 international standard for functional safety of automotive electronic systems. This allows the device to qualify for many applications for which safety is of critical importance.

The MCU 16, which may, in one embodiment, be a state machine, is used to manage the overall operation of the control unit or system 36. Upon receiving an input 10 such as a wake signal (or an ignition signal) from the vehicle, the MCU 16 oversees the booting up of the necessary sections of the control unit 36 for operation. This may include connecting the system 100 to the online information system 30 and/or booting up or initiating different power rails within the control unit 36. After boot up of the system 100 is completed, the MCU 16 may check to see if any firmware updates are available from the MPU 26. If applicable i.e. updates are available, the MPU 26 will reprogram the MCU 16 and then check for a successful update operation. Error-detecting code, such as cyclic redundancy checks and heartbeat signals, are preferably implemented on the MCU 16 and MPU 26 to monitor the application of firmware and firmware updates. Archived versions of firmware are preferably stored in a database such that if an update process is not performed correctly, the system 100 can automatically revert to known functional software or the most recent version. When the wake signal ends (sensing that the vehicle is being turned off), the MCU 16 is responsible for powering down the control unit 36, or system 100, safely and securely. In one embodiment, to power down the control unit 36, the MCU 16 may also send a power down signal or instruction to the MPU 26 which will also shut down the HMI 34 and IoT 24 components.

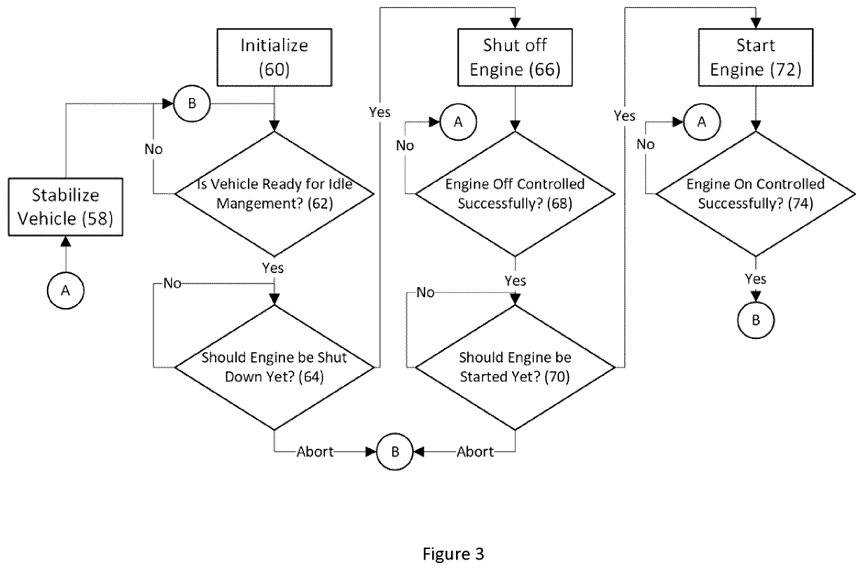

During typical operation, after the MCU 16 has connected with the online information system 30, the AIS 100 executes the method of FIG. 3 to determine when anti-idling control is required.

The control unit 36 can be configured to operate as a storage and connectivity device in addition to AIS functionality, where the storage and connectivity is handled by the MPU 26. The control unit 36 can be configured to operate as an operation recorder, storing live data for later analysis or consultation. One embodiment of this storage functionality is for the control unit to operate as a cyclic recording device, storing communication bus messages, analog, or digital signals in a timestamped manner for performance, liability, or insurance purposes.

Common messages that would be stored include, but are not limited to, fuel consumption rate, fault codes, location, acceleration, and brake pedal position. These values could be stored on internal or physically removable mediums or data storage 28 in the event that the data needs to be assessed by a customer. The recorded data is also post-processed locally by the MPU 26 to generate metrics that can be determined from the gathered data for the customer to make informed decisions. This post-processed data can include parameters such as time spent idling, fuel consumed, required action to remedy a fault code, or producing a histogram of when an emergency braking maneuver was performed. Using this analyzed data, the unit can inform the operator using the local HMI 34 or via other known methods. In the case of the local information, the system 100 may provide suggestions or instructions to the driver such as to encourage the driver to shut the engine off, drive less aggressively, or inform them what the dashboard warning light means. A cellular connection, such as via the IoT component 24, enables the same information to be broadcast real-time to the fleet operators. The fleet managers would be informed on how efficiently their vehicles are operating on the road as well as individual problems with certain vehicles. For example, lower than average fuel efficiency could indicate an electro-mechanical issue with the vehicle that should be inspected at the end of the day. Diagnosed engine fault codes can be used to pull the vehicle back into the depot before the vehicle breaks down on the side of the road.

The connected nature of the control unit 36 allows for both the fleet manager and driver to influence the behaviour of the control unit 36 without reprogramming it. The driver can modify parameters using the HMI 34 installed in the vehicles while the fleet managers can interface using a customer portal website via the online information system 30.

When the device is remotely connected, an automatic over the air update routine may be enabled for security and performance purposes. The MPU 26 will automatically check, download, and upgrade itself when updates such as security patches are available. The MPU 26 will also facilitate firmware over the air updates for the IoT component 24 for devices that require it, such as modems. Furthermore, because the programmer and debug component 22 is onboard, over the air updating of the MCU 16 is possible to push new features to the system 100 remotely.

Using the fundamental device structure, the control unit may be programmed to operated in one or more of the possible embodiments.

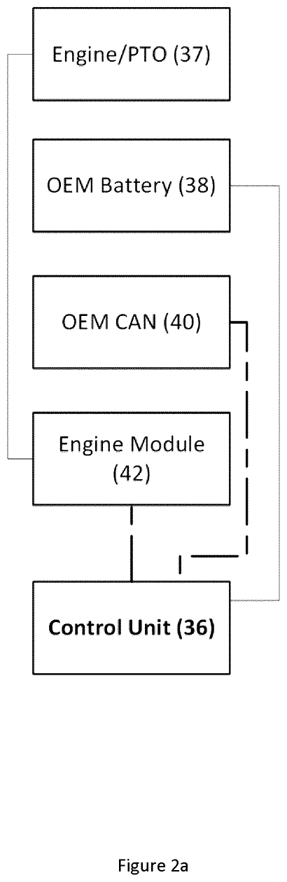

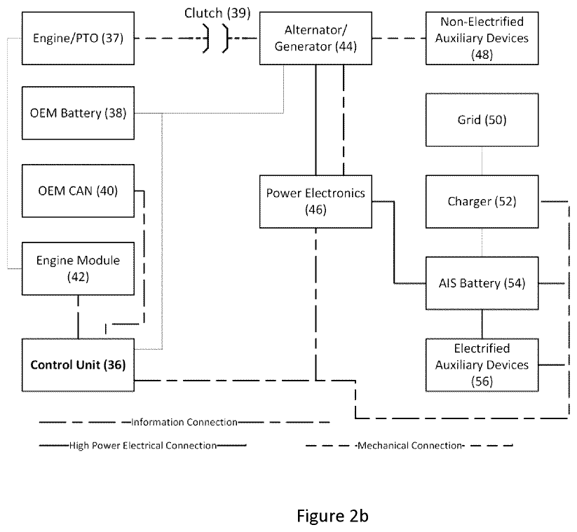

Turning to FIG. 2a, a schematic diagram of an integrated AIS system is shown. The embodiment shown in FIG. 2a shows the control unit 36 implemented within a vehicle for use in controlling anti-idling of anti-idling management. For example, the vehicle may be a city or tourist bus or a delivery truck. During service stop periods for loading/unloading, site seeing, etc., the AIS will control the engine to reduce or eliminate idling of the vehicle engine. The AIS 100 is implemented by applying or attaching the control unit 36 and a vehicle specific engine module 42 via a vehicle wiring harness. The vehicle specific harness contains the necessary hardware that allows the control unit 36 to interface with the vehicle, such as original equipment manufacturer (OEM) connectors, sensors such as hood switches, and configuration hardware such as resistors and relays. The control unit 36 is connected to a vehicle communication bus 40 while the engine module 42 communicates with an engine/PTO 37. A battery 38 powers the control unit.

The control unit 36 is programmed to execute the method of anti-idling as schematically shown in FIG. 3 and is preferably executed by the MCU 16 and the MPU 26.

If the method of anti-idling is being run for the first time, the control unit 30 automatically configures or initializes 60 the parameters used in the AIS for the particular vehicle it is installed on by scanning the communication bus 40 and setting default values. These parameters assist the system in determining if a vehicle should or should not enter an anti-idling state. Parameters set by and referenced in the AIS include, but are not limited to, primary and secondary battery nominal voltages, engine type, coolant temperature bounds, engine starter timing requirements, interior cabin temperature bounds, and the presence of safety switches. In one embodiment, the MPU may include a self-learning module to monitor the performance of the system 100 with respect to seasons, geographic locations, and component health such as battery state of charge (SOC), capacity and/or damage under load to modify AIS parameters.

After initialization 60, the vehicle is checked to determine if the vehicle is unnecessarily idling and therefore in need of anti-idling control or ready for idling management 62. In one embodiment, the MCU 16 processes measurements of components such as gear selection, but also understands specific vehicle complexities. For instance, the system 100 may use a histogram of vehicle speed and time running to determine if the vehicle has been running sufficiently long to stabilize the vehicle electrical system enough for the AIS to take over control or to implement vehicle idling management.

If the vehicle is a diesel vehicle, the after treatment system may be analyzed to determine if the AIS should take over control of the vehicle. For instance, the system may read the diesel particulate filter soot and/or ash levels and active regeneration status so as to not interrupt an active regeneration cycle by taking over control. The control unit 36 also has the ability to control the idling RPMs of the engine to improve vehicle health in anticipation of starting the AIS. If the control unit 36 determines the battery needs additional charge or the engine is running too cold, the engine RPM may be increased to remedy the problem. If the engine temperatures are too high for AIS to take over control, the control unit 36 can reduce the idling RPM to cool the engine and turbocharger (if applicable) to the ideal temperature.

If the vehicle is ready for idling management, the system determines if the vehicle is ready to be shut down as a result of unnecessary idling 64. In one embodiment, the system continuously monitors parameters such as gear selection, engine RPM, wheel speed, brake pedal position, hood switch position, door switch positions, internal temperature, external temperature, coolant temperature, battery voltage(s), and time spent idling against the pre-determined parameters set during initialization 60. Other parameters may include is the vehicle in a parked state; is the engine RPM within a predetermined RPM range; is there any speed sensed in at least one wheel; is the brake depressed; is the hood closed; is the lift door closed; is the battery voltage higher than a predetermined low battery threshold; is the state of the charge of the AIS battery is within a predefined range, is the exterior/interior temperature within a predetermined temperature range; is the vehicle undergoing an active regeneration process; and is the turbocharger temperature lower than a predetermined temperature threshold

If the vehicle has a turbocharger, the temperature of the component may also be measured and ensured to be at an adequate temperature for an engine shutdown. If needed, the system may abort the idling management if the vehicle is determined to not be unnecessarily idling or continue to check until the vehicle is ready to be shut down shortly after beginning idling. If the vehicle is ready for shutdown the system provides a message or warning to the driver using an auditory and/or visual cue (such as via the HMI 34).

The system then performs the control actions necessary to shut off the engine 66 which are specific to the vehicle type that it is installed on. This involves intercepting driver input signals and then sending the combination of signals to the engine control unit or body control module which are interpreted as an engine off command. Alternatively, the system may notify the driver to turn off the engine.

The system then verifies that the engine control process worked correctly 68 by checking the engine RPMs. If the process has not worked correctly, the vehicle is then stabilized 58.

If the engine shut down is successful, the system continuously monitors or determines if the vehicle is ready to be restarted after remaining off 70. In one embodiment, this may be performed by monitoring different parameters, which include gear selection, RPM, wheel speed, brake pedal position, hood switch position, door switch positions, internal temperature, external temperature, coolant temperatures, battery voltage(s), wait to start lamp, and time spent off. While the vehicle is off, the control unit 36 can independently control vehicle accessories like the heating, ventilation and air conditioning (HVAC) system and optimize settings between electrical SOC and passenger comfort to maximize fuel savings. For example, after some time of the vehicle remaining off, the temperature of the cabin may drop to values approaching discomfort. The AIS 100 may turn on the heater so that blower fans may reheat the cabin of the vehicle without requiring an engine start for as long as the battery SOC can sustain it. If the cabin is sufficiently reheated and the battery SOC does not indicate a necessary restart, the heater and blower fan can be shutoff without an engine restart. If the vehicle is ready for restart the algorithm will provide the driver with an auditory and/or visual cue via the HMI 34.

The system then performs the control actions necessary to turn on, or start, the engine 72. In an identical fashion to shutting down the engine, this involves intercepting driver input signals and then sending the combination of signals to the engine control unit or body control module which are interpreted as an engine on command. The system then verifies that the engine control process worked correctly 74 by checking the engine RPMs.

In the current method, the idling management may be monitored by a stabilization routine that will stop the idling management if the vehicle should be left running or abnormalities with the vehicle are detected. This stabilization routine is typically run if there are issues with controlling the vehicle, at which point the reason for the issues are identified. When appropriate the vehicle will resume the idling management.

The signals used to determine the outcomes of the methods of FIG. 3 may include the inputs 10 from analog voltage sensors and the Com component 14. The outputs 12 to the engine control unit are achieved using relays to intercept and control the signals coming from the vehicles OEM ignition system 42.

In the preferred embodiment, the idling management is controlled and executed on the MCU 16 and uses the control unit 36 to interact with the vehicle while a self learning algorithm, or neural network, is processed on the MPU 26 and communicated to the MCU 16 directly.

While the control unit 36 is running the idling management, it may communicate information such as fuel saved by AIS 100, vehicle health, and/or physical location using the GNSS system, and any detected issues with the vehicle. The online information system 30 allows for registered users to view the performance of the AIS and send commands to the unit on the road. If desired, the parameters for the AIS 100 may be modified or the idling management halted and this information would be displayed to the driver via the HMI 34.

As major software updates or new features become available, the MCU 16 may be remotely updated using the programming and debug component 22, with all updates being archived on the MPU 26.

Another embodiment of an integrated AIS is shown with respect to FIG. 2b. In FIG. 2b, the vehicle includes an auxiliary power unit.

Along with the components in FIG. 2a, the control unit 36 is connected to an alternator/generator 44 that is connected to the engine/PTO 37 via a clutch 39. The battery 38 is also connected to the alternator/generator 44. The alternator/generator 44 is connected to power electronics 46 and to non-electrified auxiliary devices 48. The power electronics 46 is connected to an AIS battery 54 which is connected to a charger 52 and electrified auxiliary devices 56. The charger 52 can also be connected to a grid 50. It will be understood that some of the connections described above may be high power electrical connection, information connections or mechanical connections. In a preferred embodiment, the system includes the AIS battery, or auxiliary power unit 54 that improves the efficacy of the system.

During service stop periods for loading/unloading, site seeing, etc., the AIS battery 54 powers the vehicle auxiliary devices to reduce or eliminate idling of the vehicle engine. This embodiment can be seen as a natural extension of the embodiment of FIG. 2a. With the addition of the auxiliary power unit 54 and added intelligence, the performance of the AIS may be improved.

The AIS battery 54 is charged when the vehicle is running and the controller manages the flow of energy between the alternator/generator 44 connected to the engine 36, battery 54, and auxiliary devices 48 and 56 using the onboard and/or external information 40 or information provided by the online system 30.

In the preferred embodiment, the battery is charged as much as possible during braking and when the engine is running at high efficiency. It also keeps the SOC of the AIS battery 54 within an optimal or preferred range whereby the battery 54 has enough energy for each stop period to power the electrified auxiliary devices 56. For non-electric auxiliary devices 48, with an independent power source like bus or truck heaters, the control unit may control of the auxiliary device directly to ensure normal operation of the auxiliary devices when the engine is turned off.

The size of the alternator/generator 44 is determined based on the power needed in the electrified auxiliary devices 56. When the power for running the electrified auxiliary devices 56 is small, an original or scaled up alternator may be used to charge the AIS battery 54 by the engine 36. Alternatively, in cases when the electrified auxiliary devices 56 require a higher level of electric power, a Power Take Off (PTO) or a similar device may be connected to the transmission or driveline that is used to add a generator to the vehicle powertrain for charging the AIS battery 54.

In this embodiment of the AIS 100, the control unit 36 receives information, or input, from the CAN bus 40, such as engine and brake status information. Other inputs may include location information, off line information (such as previously stored in the database or storage medium), and data from on-board sensors such as current, voltage, temperature, and pressure sensors. Online information may also be used through the online information system 30 such as a cellular network for up to date traffic information, scheduled routes, stops, etc., to determine a rate of flow of the energy between the engine 36, generator 44, AIS battery 54, and auxiliary devices 56. The control unit 36 further includes the MPU 26 for controlling the flow of the energy and also a self-learning module for duty cycle estimation. The AIS battery 54 can be also charged directly from the grid 50 via charger 52 to further reduce fuel consumption and increase the AIS efficiency. The data storage 28 can be used for storing the stops' locations and durations and routes of the service vehicles when it is not connected wirelessly to the fleet manager. The HMI 34 displays this information to the driver. In addition, the data collected from the operation of the AIS 100 can be transmitted through the IoT component 24 to the operator or fleet manager and/or saved in the data storage 28 for later use.

In a daily operation of a service vehicle equipped with the AIS 100 of the disclosure, it is assumed that the AIS battery is charged from the grid 50 and it is full prior to use of the service vehicle. Vehicle route information (seen as on-line information 30 in FIG. 1), such as the stops that the service vehicle is expected to make is provided by an external party, such as a computer associated with one of the fleet managers, preferably wirelessly to the IoT component 24 or from the data storage medium 28 downloaded to the AIS control unit 36. The AIS control unit 36 is also in communication with the onboard computer of the service vehicle to receive all or partial engine, vehicle, and sensor data from components such as, but not limited to, a CAN bus, current and/or voltage sensors, and/or temperature and/or pressure sensors to control the energy flow between the alternator/generator 44 and the AIS battery 54.

In operation, if the control unit 36 senses (via the input data provided by the components) that the state of the battery charge is lower than a predefined value, the control unit 36 may start charging the AIS battery 54 from the generator 44. In one embodiment, if the battery needs charging, when the control unit 36 determines that the engine is running at a high efficiency using the engine load information and engine speed data from the CAN bus 40 and the engine efficiency map from the data storage unit 28, the control unit 36 charges the battery 54. In one embodiment, the engine efficiency map provides engine efficiency as a function of the engine load and engine speed. In addition, the control unit 36 may monitor if the driver is using the brake in order to activate battery charging to increase or maximize energy recuperation from regenerative braking.

In a preferred embodiment, the size or capacity of the AIS battery 54 is determined by calculating or determining a maximum or average stop time of the service vehicle and the power needed to run the electrified auxiliary devices when the service vehicle is idled. Depending on the type of the battery and average number of stops, the state-of-charge (SOC) swing (the maximum range that the SOC of the AIS battery varies during charging and discharging) may be determined. This SOC swing should be equal to the energy needed to run the auxiliary devices for the longest stop duration.

In a preferred embodiment, the size of the alternator/generator 44 is determined by the size and the charging feature of the battery (C rate) to ensure that it can charge the battery during the vehicle operation between the stops. The C-rate of a battery is a measure of the rate at which a battery is discharged relative to its maximum capacity.

The AIS control unit 36 ensures that the battery SOC is sufficient to run the auxiliary devices 56 at each stop. When the vehicle stops and the engine turns off, the auxiliary devices will be powered only by the AIS battery 54. As such, the AIS control 36 monitors the SOC of the battery 54 that it does not drop below a low or minimum threshold. In case of any unexpected delay or longer stops that the battery SOC drops below the low or minimum threshold, the AIS controller starts the engine automatically or signals the driver through the HMI to start the engine to reduce or eliminate any interruption in the operation of the auxiliary devices. A self-learning module in the AIS control unit 36 preferably monitors the stops and power used by the auxiliary devices with respect to temperature, seasons, etc. . . . to adjust the battery SOC for each stop to reduce any need to turn the engine on while in a stop due to lack of enough stored energy in the battery.

Compared to the existing systems, the AIS of the disclosure has at least one of the following advantages. The AIS 100 does not rely on a small-scaled engine to run auxiliary devices; therefore, it will be quieter and cleaner than conventional auxiliary power units (APUs). Also, the AIS can be implemented such that only the addition of the control unit is necessary to enable AIS. Also, while similar to anti-idling systems with auxiliary battery packs (ABP), the system of the disclosure may recover braking energy, and store energy when the engine is in high efficiency operation mode; therefore, resulting in lower costs and higher efficiency. Another advantage is that the control unit may increase and/or maximize the efficiency of the AIS to reduce and/or minimize fuel consumption by managing the power flow between the engine, AIS battery, and auxiliary devices while providing the functionality and performance needed for the auxiliary devices.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether elements of the embodiments described herein are implemented as a software routine, hardware circuit, firmware, or a combination thereof.

Embodiments of the disclosure or components thereof can be provided as or represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor or controller to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor, controller or other suitable processing device, and can interface with circuitry to perform the described tasks.

What is claimed is:

1. A method for determining if a vehicle should enter an anti-idling state comprising:
determining if the vehicle is ready for idling management;
determining if the vehicle engine should be shut down; and
if it is determined that the vehicle engine should be shut down, shutting down the vehicle engine.

2. The method of claim 1 wherein determining if the vehicle engine should be shut down comprises:
determining at least one of: is the vehicle in a parked state; is the engine RPM within a predetermined RPM range; is there any speed sensed in at least one wheel; is the brake depressed; is the hood closed; is the lift door closed; is the battery voltage higher than a predetermined low battery threshold; is the state of the charge of the AIS battery is within a predefined range, is the exterior/interior temperature within a predetermined temperature range; is the vehicle undergoing an active regeneration process; and is the turbocharger temperature lower than a predetermined temperature threshold.

3. The method of claim 1 further comprising:
determining if the vehicle engine should be turned back on.

4. The method of claim 3 wherein determining if the vehicle engine should be turned back on comprises:
determining if a battery voltage is lower than a predetermined low battery threshold; determining if a state of the charge of an anti-idling system (AIS) battery is lower than a predefined AIS battery threshold and/or determining if an exterior/interior temperature is outside a predetermined temperature range.

5. The method of claim 2 wherein determination of is the brake depressed comprises:
determining if there is a brake pedal input for a digital brake switch; and
determining if a brake pedal value is less than a predetermined brake pedal error threshold for an analog brake switch.

6. The method of claim 1 further comprising, before determining if the vehicle is ready for idling management:
determining parameters for initiating idling management.

7. The method of claim 6 wherein determining if the vehicle is ready for idling management comprises:
comparing measurements received from vehicle with the determined parameters to determine if a threshold with respect to the determined parameters is met.

8. The method of claim 1 further comprising:
processing vehicle information to determine vehicle characteristics;
transmitting vehicle characteristics to an external party.

9. A system for determining if a vehicle should enter an anti-idling state comprising:
a set of sensors for sensing vehicle characteristics and generating vehicle characteristic signals representing the sensed vehicle characteristics; and
a processor for receiving the vehicle characteristic signals from the set of sensors and for processing the vehicle characteristic signals to determine if the vehicle should enter the anti-idling state and for transmitting vehicle engine instructions based on the processing.

10. The system of claim 9 further comprising a power management module to manage a flow of the energy between vehicle components.

11. The system of claim 10 wherein the vehicle components comprise at least two of an engine, an OEM battery, an AIS battery, auxiliary devices, an alternator/generator, and power electronics.

12. The system of claim 9 further comprising an inertial measurement unit to assist the decision making in the control unit.

13. The system of claim 9 further comprising a communication component for communicating vehicle characteristics to an external party.

14. The system of claim 11 wherein the AIS battery is used to power electrified auxiliary devices when the engine is shut off.

15. A computer readable medium having stored thereon instructions that, if executed, cause a processor to:
determine if the vehicle is ready for idling management;
determine if the vehicle engine should be shut down; and
if it is determined that the vehicle engine should be shut down, shutting down the vehicle engine.
